(19) United States
(12) Patent Application Publication
(10) Pub. No.: US 2026/0121776 A1
(43) Pub. Date: Apr. 30, 2026

(54) COMMUNICATION MANAGEMENT IN DISTRIBUTED SYSTEMS

(71) Applicant: Dell Products L.P., Round Rock, TX (US)

(72) Inventors: ROMAN BOBER, Ashdod (IL); MAXIM BALIN, Gan-Yavne (IL)

(21) Appl. No.: 18/930,335

(22) Filed: Oct. 29, 2024

(51) Int. Cl. H04J 3/06

(52) U.S. Cl. CPC H04J 3/0638

(57) ABSTRACT

Methods and systems for managing operation of a deployment of data processing systems are disclosed. The operation may be managed by determining a synchronicity classification of data that is to be transmitted between the data processing systems, and performing the transmission based on the synchronicity classification. The data may be classified as synchronous and/or asynchronous. If the data is classified as synchronous, then the data may be transmitted through a synchronous channel immediately and/or at a predetermined future time when the synchronous channel is operational. Otherwise, if the data classified as asynchronous, then the data may be appended to a queue of data to be transmitted at a future time.

### FIELD

Embodiments disclosed herein relate generally to managing operation of a distributed system. More particularly, embodiments disclosed herein relate to communication management in distributed systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2D show data flow diagrams illustrating operation of a system in accordance with an embodiment.

FIGS. 3A-3C show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment of data processing systems. The deployment may be managed by performing at least one transmission of data between data processing systems based on a synchronicity classification.

The data may be classified as synchronous data (i.e., the data that is transmitted and/or processed in real-time and/or with minimal delay to ensure that a response by a first data processing system occurs in a coordinated and/or immediate sequence) and/or asynchronous data (i.e. the data that is transmitted and/or processed independently of the real-time and does not require the response by the first data processing system to occur in a coordinated and/or immediate sequence).

The data may be classified by assessing characteristics of the data. The characteristics may be assessed from an analysis of processes that utilize the data. The processes may include synchronous and/or asynchronous operations.

Based on the synchronicity classification, a first channel may be selected through which to transmit the data from a second data processing system to the first data processing system. The first channel may be established to transmit synchronous data. Further, a second channel may be established to transmit asynchronous data.

If a state of the first channel is non-operational, then the synchronous data may be transmitted as soon as the first channel becomes operational and/or at a first predetermined future time. Further, the second channel may transmit, at a second predetermined future time, asynchronous data that has been added to a queue before transmission of the data takes place.

In an embodiment, a method for managing operation of a deployment of data processing systems is disclosed. The method may include: (i) obtaining, by a data processing system of the data processing systems, a portion of data to be provided to another data processing system of the data processing systems to facilitate performance of a desired computer implemented service, (ii) obtaining, by the data processing system and using a synchronicity classification schema, a synchronicity classification for the portion of the data, (iii) in a first instance of the obtaining where the synchronicity classification indicates that the portion of the data is to be distributed synchronously: (a) obtaining, by the data processing system, a channel identifier for synchronous transmission of the portion of the data to the other data processing system, (b) identifying, by the data processing system, a state of a channel identified using the channel identifier and (c) providing, by the data processing system, the portion of the data to the other data processing system while the state of the channel is in a desired state.

The method may further include, in a second instance of the obtaining where the synchronicity classification indicates that the portion of the data is to be distributed asynchronously: (i) obtaining, by the data processing system, a second channel identifier for asynchronous transmission of the portion of the data to the other data processing system, (ii) identifying, by the data processing system, a queue for an asynchronous channel to the other data processing system and (iii) adding, by the data processing system, the portion of the data to the queue to facilitate future distribution of the portion of the data to the other data processing system during a period of time when the asynchronous channel is operational.

Identifying the state of the channel may include, for a period of time during which the portion of the data will be transmitted to the other data processing system: inferring whether the channel between the data processing system and the other data processing system will be operational during the period of time.

Providing the portion of the data to the other data processing system while the state of the channel is in the desired state may include, in a first instance of the inferring where the channel will not be operational during at least a portion of the period of time: selecting a different period of time during which to transmit the portion of the data to the other data processing system via the channel.

Providing the portion of the data to the other data processing system while the state of the channel is in the desired state may include, in a second instance of the inferring where the channel will be operational during all of period of time: selecting the period of time during which to transmit the portion of the data to the other data processing system via the channel.

The period of time may have a duration sufficient to (i) distribute the portion of the data to the other data processing system via the channel and (ii) facilitate obtaining of a response from the other data processing system.

The response may be based, at least in part, on the portion of the data.

The response may be required for the data processing system to provide the desired computer implemented service.

The desired computer implemented service may be a distributed process performed by at least the data processing system and the other data processing system, and the distributed process requires separate timely activity of the data processing system and the other data processing system.

The method may further include, prior to obtaining the portion of the data: (i) obtaining, by the data processing system, a grouping instruction indicating member of the data processing system in a group with the other data processing system and (ii) establishing, by the data processing system and based on the grouping instruction, the channel and an asynchronous channel to the other data processing system, the channel being a synchronous channel for timely cooperative action by the data processing system and the other data processing system.

The data processing systems may orchestrate operation of a manufacturing environment in which timely coordination between the data processing systems is required.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

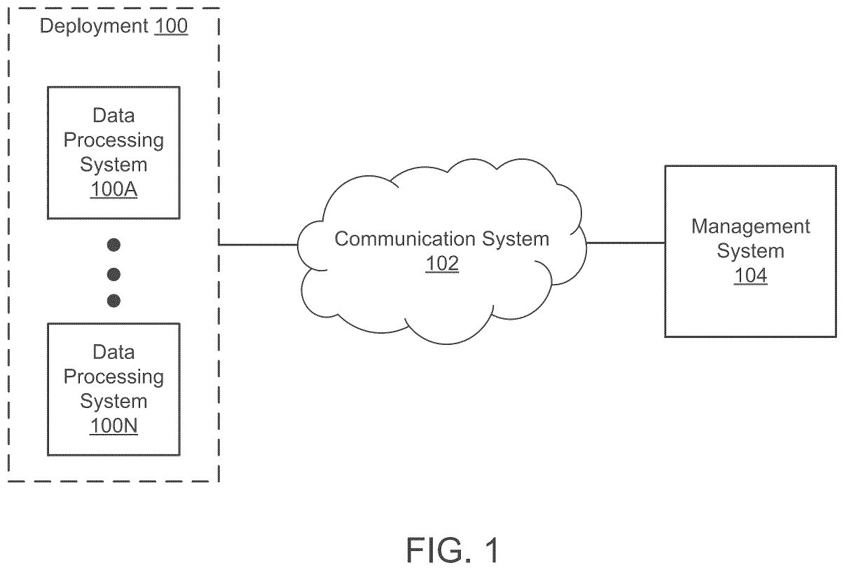

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, data may be transmitted from a data processing system to a second data processing system. The data may be passed using a communication protocol that uses shared memory, a data stream, a socket connection, etc. to perform a transmission. The data may be passed to enable performance of at least one task by the second data processing system. The at least one task may include an operation by an application. To perform the task, transmission of the data by the data processing system to the second data processing system may need to be performed in a timely manner (e.g., immediately, at a future time, etc.).

Before the transmission of the data, the communication protocol may fail (e.g., due to network issues, resource exhaustion, timeouts, etc.) and/or the second data processing system may be unresponsive (e.g., due to resource exhaustion, software bugs, memory leaks, etc.). If the communication protocol fails, the data processing system may not be able to transmit the data to the second data processing system. Similarly, if the second data processing system is unresponsive, the second data processing system may not be able to receive the data after the data is transmitted by the data processing system. In either case, computer implemented services that utilize data transmitted between data processing system may be impacted (e.g., impaired, may fail entirely, etc.).

In general, embodiments disclosed here relate to systems and methods for managing operation of a deployment of data processing systems. The operation of the deployment may be managed by (i) determining a synchronicity classification of the data to be sent from the data processing system to the second data processing system and (ii) performing the transmission of the data based on the synchronicity classification.

The synchronicity classification may be determined by assessing characteristics of the data. The characteristics may be assessed from an analysis of processes that utilize the data. The processes may include (i) real-time processes (e.g., video streaming, online transactions, real-world sensors, etc.), (ii) high frequency processes (e.g., market trades, the real-world sensors, web analytics, etc.), (iii) coordinated processes (e.g., distributed databases, microservices architecture, manufacturing systems, etc.), etc.

The analysis may determine whether the synchronicity classification of the data is synchronous (i.e., data that is transmitted and/or processed in real-time and/or with minimal delay to ensure that a response by the second data processing system occurs in a coordinated and/or immediate sequence) and/or asynchronous (i.e., data that is transmitted and/or processed independently of the real-time and does not require the response by the second data processing system to occur in a coordinated and/or immediate sequence).

Once the synchronicity classification is obtained, a channel identifier may be obtained. The channel identifier may be obtained by performing a search in a registry for the channel identifier between the data processing system and the second data processing system. The channel identifier may have been assigned by a management system and stored in the registry before the transmission of any data.

Once the channel identifier has been obtained, the data may be handled based on the synchronicity classification. If the synchronicity classification of the data is synchronous, then a state of the channel may be obtained. The state of the channel may be obtained by receiving (i) periodic messages from the second data processing system to the data processing system (e.g., discontinuation of at least one periodic message may indicate the channel is down), (ii) an indicator status (e.g., open, closed, etc.) from the communication protocol relating to the state of the channel when the state of the channel changes, etc. Based on the state of the channel, when the channel is open, the data may be transmitted from the data processing system to the second data processing system. However, if the synchronicity classification of the data is asynchronous, then the data may be set in a queue. The queue may facilitate distribution of the data by permitting the transmission of the data at a future time through the channel when the channel is in an open state.

To provide the above noted functionality, the system may include deployment 100, and management system 104. Each of these components is discussed below.

Deployment 100 may include any number of data processing system 100A-100N. The any number of data processing system 100A-100N may perform at least one operation. The at least one operation may be performed by ingesting data. The data may be obtained from a first data processing system (e.g., 100A) and transmitted through a channel to a second data processing system (e.g., 100B).

The data may be synchronous and/or asynchronous. Synchronous data may be transmitted and/or processed in real-time and/or with minimal delay to ensure that a response by the second data processing system (e.g., 100B) occurs in a coordinated and/or immediate sequence. Asynchronous data may be transmitted and/or processed independently of the real-time and does not require the response by the second data processing system (e.g., 100B) to occur in a coordinated and/or immediate sequence.

The first data processing system (e.g., 100A) may determine whether the data is synchronous and/or asynchronous. The first data processing system (e.g., 100A) may make the determination by assessing characteristics of the data. The characteristics may be assessed from an analysis of processes performed the any number of the data processing system 100A-100N that utilize the data. The processes may include (i) real-time processes (e.g., video streaming, online transactions, real-world sensors, etc.), (ii) high frequency processes (e.g., market trades, the real-world sensors, web analytics, etc.), (iii) coordinated processes (e.g., distributed databases, microservices architecture, manufacturing systems, etc.), etc.

The first data processing system (e.g., 100A) may receive at least one notification of a state of the channel. The at least one notification may be received by obtaining (i) periodic messages from the second data processing system (e.g., 100B) (e.g., discontinuation of at least one periodic message may indicate the channel is down), (ii) an indicator status (e.g., open, closed, etc.) from a communication protocol (e.g., 102) relating to the state of the channel when the state of the channel changes, etc.

If the synchronicity classification of the data is synchronous, then, based on the state of the channel, when the channel is open, the data may be transmitted from the first data processing system (e.g., 100A) to the second data processing system (e.g., 100B). However, if the synchronicity classification of the data is asynchronous, then the data may be set in a queue. The queue may facilitate distribution of the data by permitting the transmission of the data at a future time through the channel when the channel is in an open state.

Management system 104 may facilitate organization of deployment 100. The organization of deployment 100 may include (i) assigning the any number of data processing system 100A-100N to one or more groupings, (ii) identifying at least one channel between at least two of the any number of data processing system 100A-100N to the one or more groupings, (iii) assigning an identifier to the at least one channel, (iv) identifying the at least one channel as a transmission pathway for synchronous data and/or asynchronous data, (v) storing the channel identifier of the at least one channel in the registry that is accessible to the any number of the data processing system 100A-100N.

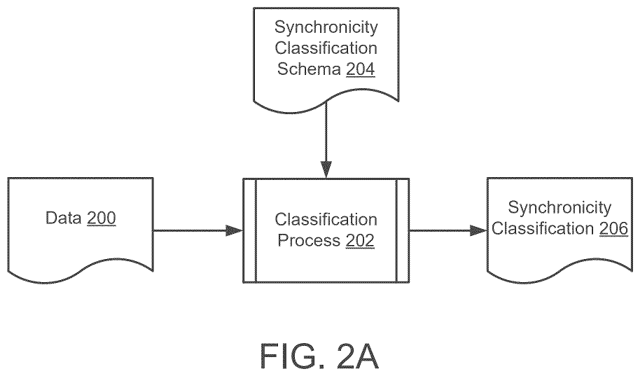

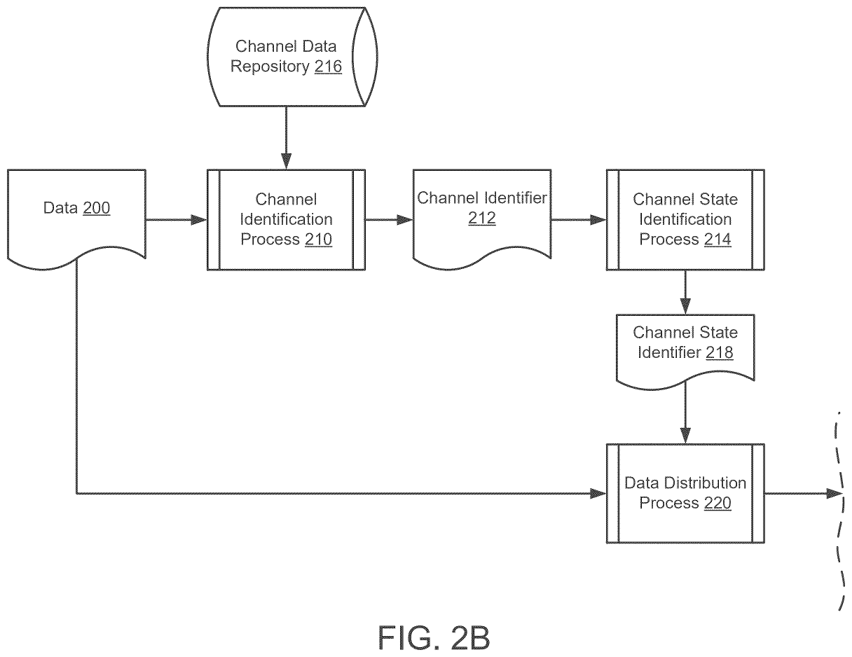

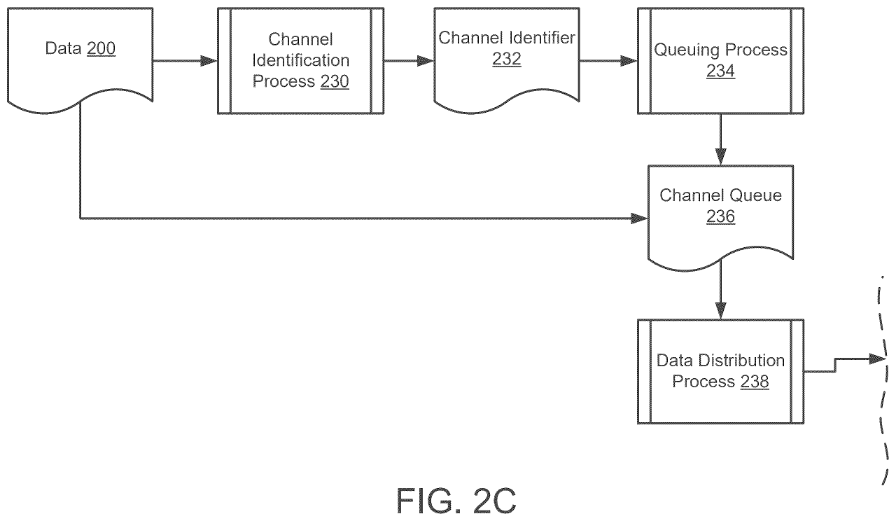

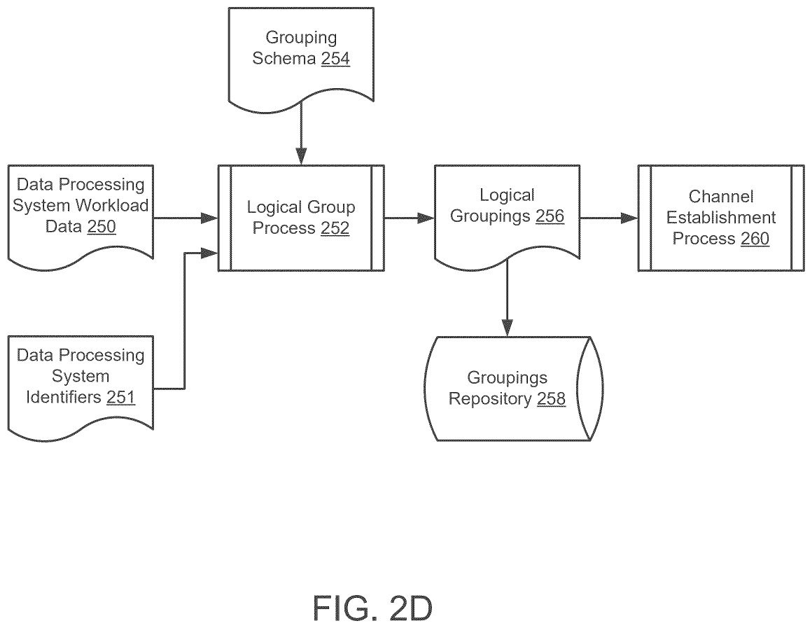

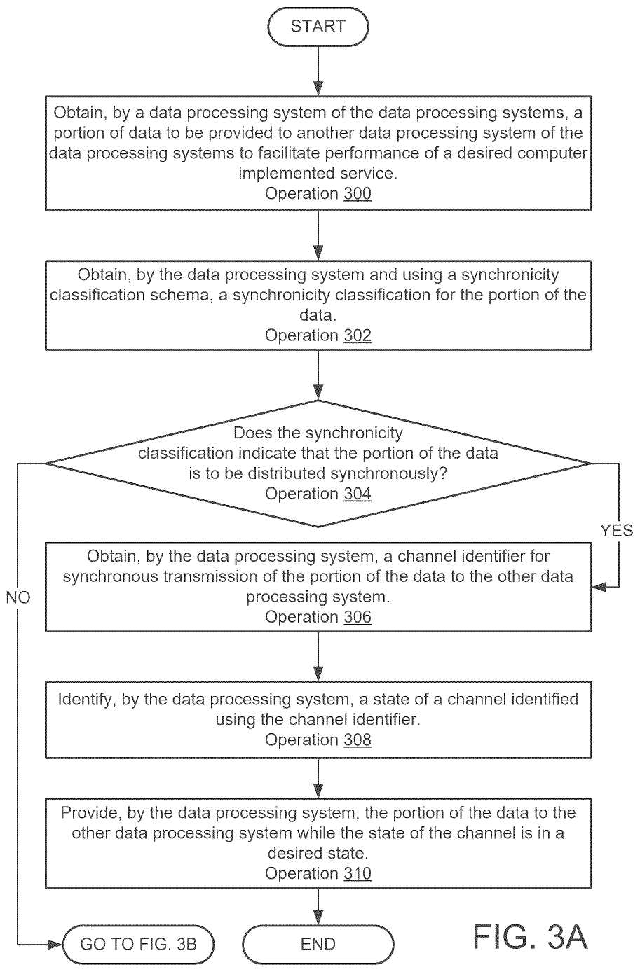

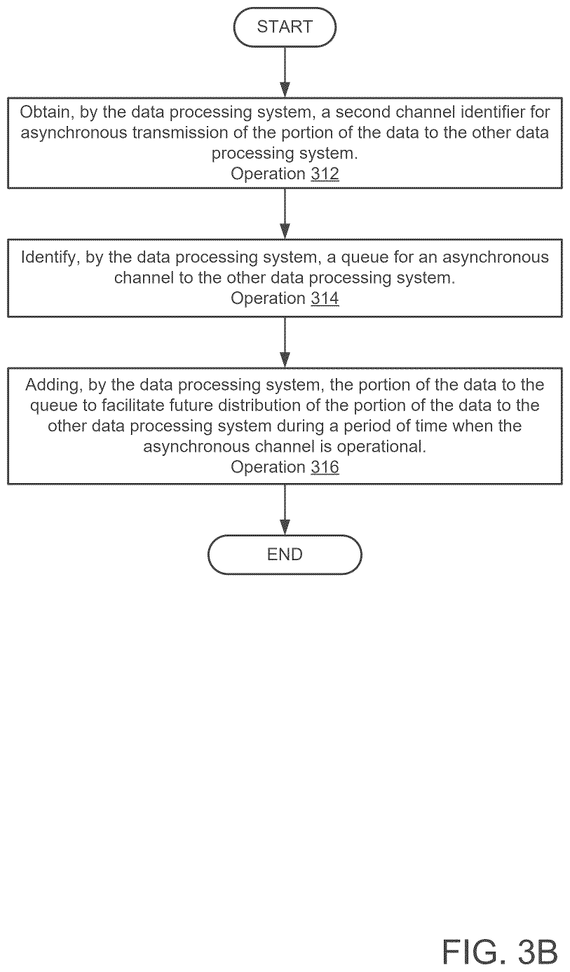

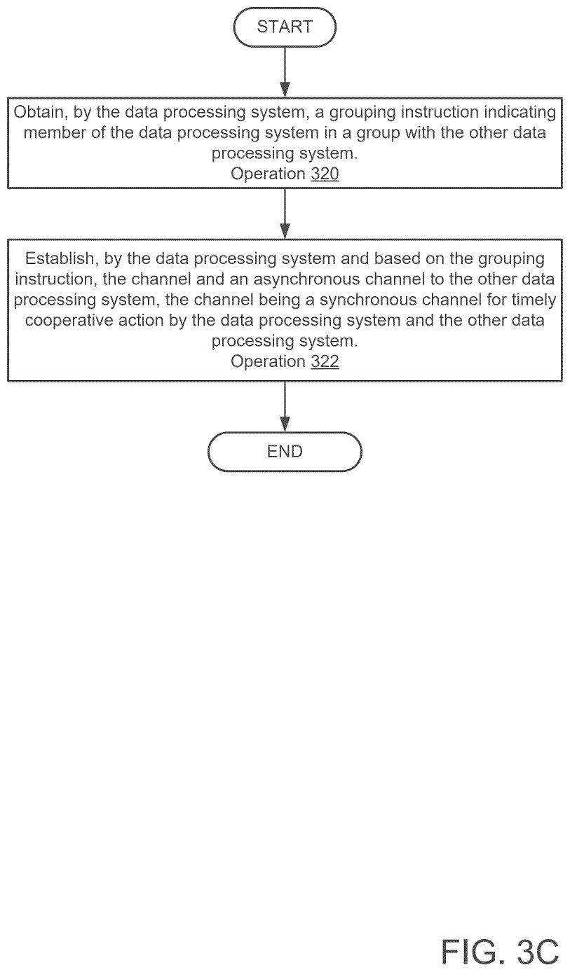

While providing their functionality, any of deployment 100 and management system 104 may perform all, or a portion, of the flows and methods shown in FIGS. 2A-3C.

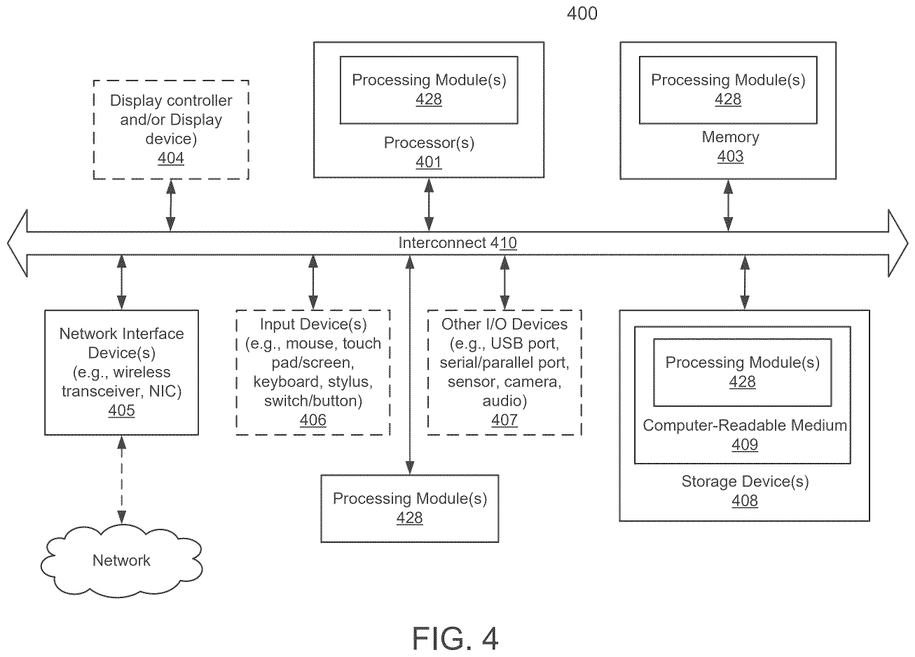

Any of (and/or components thereof) deployment 100 and management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 200, 206, etc.) is used to represent data structures, a second set of shapes (e.g., 202, 210, etc.) is used to represent processes performed using and/or that generate data, and a third set of shapes (e.g., 216, 258, etc.) is used to represent large scale data structures such as databases.

Turning to FIG. 2A, a first data flow diagram in accordance with an embodiment is shown. The first data flow diagram may illustrate data used in and data processing performed in determining a synchronicity classification of the data.

To determine the synchronicity classification of the data, classification process 202 may be performed. During classification process 202, data 200 may be first ingested. Data 200 may be a data structure that can be used by a data processing system (e.g., 100A) to perform at least one operation. The operation may be part of at least one process, which includes at least one operation. The outcome of the process may be a second data structure, computer implemented services, etc.

To classify data 200, synchronicity classification 204 may be used. Data 200 may be classified as synchronous data and/or asynchronous data. Synchronous data may be data that is transmitted and/or processed in real-time and/or with minimal delay to ensure that a response by a second data processing system (e.g., 100B) occurs in a coordinated and/or immediate sequence. Asynchronous data may be data that is transmitted and/or processed independently of the real-time and does not require the response by the second data processing system (e.g., 100B) to occur in a coordinated and/or immediate sequence.

To classify data 200, characteristics of data 200 may be assessed. The characteristics may be assessed from an analysis of processes that utilize data 200. The processes may include (i) real-time processes (e.g., video streaming, online transactions, real-world sensors, etc.), (ii) high frequency processes (e.g., market trades, the real-world sensors, web analytics, etc.), (iii) coordinated processes (e.g., distributed databases, microservices architecture, manufacturing systems, etc.), etc.

Based on the assessment of the processes that use data 200, a determination may be made on whether data 200 is synchronous data and/or asynchronous data. The determination may be made by identifying which of the processes in a data processing system (e.g., 100A) can and/or will likely ingest data 200. Based on the identification, synchronicity classification 206 may be obtained. Synchronicity classification 206 may include a label and/or tag that can be embedded in metadata of data 200. The label and/or tag may have a string value of synchronous and/or asynchronous.

Thus, via the interaction illustrated in FIG. 2A, a system in accordance with an embodiment may determine the synchronicity classification of the data. Consequently, a deployment (e.g., 100) may be more likely to be able to provide desired computer implemented services by determining, by the synchronicity classification of the data, at least one manner in how the data is treated in at least one process. Turning to FIG. 2B, a second data flow diagram in accordance with an embodiment is shown. The second data flow diagram may illustrate data used in and data processing performed in performing a transmission of synchronous data from a data processing system (e.g., 100A) to a second data processing system (e.g., 100B).

To perform the transmission of synchronous data from a data processing system (e.g., 100A) to a second data processing system (e.g., 100B), channel identification process 210 may be performed. During channel identification process 210, data 200 may be ingested. Data 200 may be ingested and used to (i) identify the second data processing system (e.g., 100B) and/or (ii) identify the channel between the data processing system (e.g., 100A) and the second data processing system (e.g., 100B).

The second data processing system (e.g., 100B) may be identified by performing a search, by the data processing system (e.g., 100A), in groupings repository 258 (in FIG. 2D). Groupings repository 258 may be stored on at least one data processing system of deployment 100 and/or management system 104. Groupings repository 258 may store a list of at least one grouping of data processing systems. The at least one grouping may be assigned based on at least one process that is performed between two and/or more data processing systems.

The search by the data processing system (e.g., 100A) may identify that, for example, the data processing system (e.g., 100A) is grouped with the second data processing system (e.g., 100B) and a third data processing system (e.g., 100C). Further, the search may identify that the second data processing system (e.g., 100B) includes the at least one process for ingesting, for example, installation data that includes an instruction for a manufacturing assembly line device to update information on a second device on a car that is moving on an assembly line. Because the second data processing system (e.g., 100B) is the only data processing system identified that requires the installation data, then the data processing system (e.g., 100A) may identify that data 200 may be transmitted to the second data processing system (e.g., 100B).

To identify the channel by which to transmit data 200, the first data processing system (e.g., 100A) may perform a second search in a registry for the channel identifier between the data processing system (e.g., 100A) and the second data processing system (e.g., 100B). The channel identifier may have been assigned by a management system (e.g., 104) (logical group process 252 in FIG. 2D) and stored in the registry before the transmission of any data can take place. The registry may be stored in management system 104 and be accessible by a data processing system (e.g., 100A, 100B, etc.).

As a result of the second search, channel identifier 212 may be identified by the data processing system (e.g., 100A). Channel identifier 212 may include a serial number and/or an alphanumeric code to identify the channel. Channel identifier 212 may include a label, for example, an S tag in the alphanumeric code and/or a synchronous tag in metadata about channel identifier 212 in the registry. Therefore, a channel labeled with channel identifier 212 may be an appropriate channel through which to synchronous data.

Further, since data 200 includes, in the example, the instruction for the manufacturing assembly line device to update the information on the second device on the car that is moving on the assembly line, data 200 may be determined, during classification process 202 in FIG. 2A, that data 200 is synchronous data. Therefore, data 200 may be sent through the channel that is identified by channel identifier 212.

Before sending data 200 through the channel, channel state identification process 214 may be performed. During channel state identification process 214, a state of the channel may be obtained. The state of the channel may be obtained, by the data processing system (e.g., 100A), by receiving (i) at least one periodic message from the second data processing system (e.g., 100B) (e.g., discontinuation of the at least one periodic message may indicate the channel is down), (ii) an indicator status (e.g., open, closed, etc.) from the communication protocol relating to the state of the channel when the state of the channel changes, etc.

From channel state identification process 214, channel state identifier 218 may be obtained. From (i) the at least one periodic message, (ii) the indicator status, etc. channel state identifier 218 may include a state such as open (e.g., the channel is functional for transmission of data), closed (e.g., the channel has been shut down), error (e.g., an error has occurred on the channel), etc.

Based on channel state identifier 218, data distribution process 220 may be performed. During data distribution process 220, data 200 may be ingested. If the channel has a state, for example, that is open, then data 200, which has been classified as synchronous data, may be transmitted in real-time and/or with minimal delay to the second data processing system (e.g., 100B). However, if the channel has a state, for example, which is closed, and/or error, then data 200 may be transmitted as soon as the state of the channel becomes open. Data 200 may be transmitted using a communication protocol that uses shared memory, a data stream, a socket connection, etc.

Thus, via the interaction illustrated in FIG. 2B, a system in accordance with an embodiment may perform the transmission of the synchronous data from the data processing system (e.g., 100A) to the second data processing system (e.g., 100B). Consequently, a deployment (e.g., 100) may be more likely to be able to provide desired computer implemented services by transmitting synchronous data to a data processing system that performs at least one process that requires receiving the synchronous data in real-time and/or with minimal delay.

Turning to FIG. 2C, a third data flow diagram in accordance with an embodiment is shown. The third data flow diagram may illustrate data used in and data processing performed in transmitting asynchronous data from a data processing system (e.g., 100A) to a second data processing system (e.g., 100B).

To transmit the asynchronous data from the data processing system (e.g., 100A) to the second data processing system (e.g., 100B), channel identification process 230 may be performed. Channel identification process 230 may be performed similarly to channel identification process 210. Data 200, that is ingested by channel identification process 230, for example, may include asynchronous data. An example of asynchronous data that may be included in data 200 may be, for example, an instruction for a manufacturing assembly line device to take a sample of a random set of measurements from a car that been completed on manufacturing assembly line.

Channel identifier 232, similar to channel identifier 212 from FIG. 2B, may include a serial number and/or an alphanumeric code to identify the channel. Channel identifier 232 may include a label, for example, an A tag in the alphanumeric code and/or an asynchronous tag in metadata about channel identifier 232 in the registry. Therefore, a channel labeled with channel identifier 232 may be an appropriate channel through which to asynchronous data may be transmitted.

For asynchronous data, queuing process 234 may be performed. During queuing process 234, data 200 may be transmitted at a future time. To prepare for the transmission, data 200 may be added to channel queue 236. Any data, including data 200, that has been added to channel queue 236, may include a timestamp. The timestamp may be the future time at which data 200 may be transmitted to the second data processing system (e.g., 100B).

When the future time has elapsed, data distribution process 238 may be performed. During data distribution process 238, data 200 may be transmitted to the second data processing system (e.g., 100B) through a channel labeled with channel identifier 232. Data 200 may be transmitted using a communication protocol that uses shared memory, a data stream, a socket connection, etc. In addition, if an indication is provided by the second data processing system (e.g., 100B) that the channel has an state that indicates, for example, being closed and/or having at least one error (e.g., channel state identification process 214), then data 200 may be transmitted to the second data processing system (e.g., 100B) as soon as the state indicates that the channel is open, functional, etc.

Thus, via the interaction illustrated in FIG. 2C, a system in accordance with an embodiment may transmit the asynchronous data from the data processing system (e.g., 100A) to the second data processing system (e.g., 100B). Consequently, a deployment (e.g., 100) may be more likely to be able to provide desired computer implemented services by transmitting the asynchronous data to a data processing system that performs at least one process at a predetermined future time.

Turning to FIG. 2D, a fourth data flow diagram in accordance with an embodiment is shown. The fourth data flow diagram may illustrate data used in and data processing performed in establishing at least one channel between at least two data processing systems.

To establish the at least one channel, logical grouping process 252 may be performed. During logical grouping process 252, data processing system identifiers 251 may be ingested. Data processing system identifiers 251 may include a list of at least one serial number, alphanumeric code, etc. for at least one data processing system (e.g., 100A, 100B, etc.) of a deployment (e.g., 100). A data processing system identifier of data processing system identifiers 251 may be assigned to the at least one data processing system (e.g., 100A, 100B, etc.) by management system 104, and/or may be included in the at least one data processing system (e.g., 100A, 100B, etc.).

During logical grouping process 252, data processing system workload data 250 may be ingested. Data processing system workload data 250 may include at least process that can likely be performed by the at least one data processing system (e.g., 100A, 100B, etc.). The at least one process may be linked with at least another process so that the at least one data processing system (e.g., 100A, 100B, etc.) may produce data that may be passed to and ingested by a second data processing system (e.g., 100C, 100D, etc.). As well, data processing system workload data 250 may include at least one type of data that can be ingested by the at least one data processing system (e.g., 100A, 100B, etc.). The at least one data processing system (e.g., 100A, 100B, etc.) may include at least one application, application programming interface (API), etc. to ingest at least one data type of multiple data types.

During logical grouping process 252, grouping schema 254 may be ingested. Grouping schema 254 may include a structured framework for organizing the at least one data processing system (e.g., 100A, 100B, etc.) into at least one group. The structured framework may be based on at least one operation to be performed by the at least one data processing system (e.g., 100A, 100B, etc.). The at least one operation may include at least one process that can be performed by the at least one data processing system (e.g., 100A, 100B, etc.).

During logical group process 252, data processing system identifiers 251 may be assessed for a likely performance of at least one workload in the at least one data processing system (e.g., 100A, 100B, etc.). Assessment for the likely performance may include screening at least one data processing system (e.g., 100A, 100B, etc.) for the at least one process performed by least one data processing system (e.g., 100A, 100B, etc.). The screening may include searching for at least two processes that are linked.

For example, performance of the at least one process may require first data that may be generated by a first data processing system (e.g., 100A). Further, the first data may be frequently used by a second data processing system (e.g., 100B) for performance of at least a second process. Thus, the first data processing system (e.g., 100A) may be expected to transmit the first data to the second data processing system (e.g., 100B). Therefore, a first identifier of first data processing system (e.g., 100A) and a second identifier of the second data processing system (e.g., 100B) may be linked and therefore may be included in a grouping by a management system (e.g., 104).

As a result, logical groupings 256 may be generated. Logical groupings 256 may include at least one list that includes at least two data processing systems (e.g., 100A, 100B, etc.). The at least two data processing systems in the at least one list may be at least expected to ingest data, perform at least one process using the data, and transmit the data between the at least two data processing systems. The data may be synchronous data and/or asynchronous data. Synchronous data may be transmitted in real-time and/or with minimal delay. Asynchronous data may be transmitted and/or processed independently of the real-time and does not require the response by a receiving data processing system to occur in a coordinated and/or immediate sequence.

Logical groupings 256 may be stored in groupings repository 258. Groupings repository 258 may be stored on at least one data processing system of deployment 100 and/or management system 104. Groupings repository 258 may store the at least one list that includes at least two data processing systems (e.g., 100A, 100B, etc.) that can perform the transmission of the synchronous data and/or the asynchronous data.

To enable performance of the transmission of the synchronous data and/or the asynchronous data, channel establishment process 260 may be performed. During channel establishment process 260, a communication protocol may establish at least one channel between at least two data processing systems (e.g., 100A, 100B, etc.). The communication protocol may (i) follow administrative guidelines, (ii) use authentication and/or authorization by including a certificate, signature, etc. on the synchronous data and/or the asynchronous data that is transmitted, (iii) use a checksum and/or hash function to verify an integrity of the synchronous data and/or the asynchronous data, (iv) use at least one encryption method to protect against unauthorized access of the synchronous data and/or the asynchronous data, (v) record at least one timestamp of at least one transmission of the synchronous data and/or the asynchronous data, etc.

Thus, via the interaction illustrated in FIG. 2D, a system in accordance with an embodiment may establish the at least one channel between the at least two data processing systems (e.g., 100A, 100B, etc.). Consequently, a deployment (e.g., 100) may be more likely to be able to provide desired computer implemented services by enabling transmission of the synchronous data and/or the asynchronous data between the at least two data processing systems (e.g., 100A, 100B, etc.).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a deployment of data processing systems. FIGS. 3A-3B illustrate a method that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing operation of a deployment of data processing systems in accordance with an embodiment is shown. The method may be performed, for example, by any of the components of the system of FIG. 1, and/or other components not shown therein.

At operation 300, a portion of data may be obtained, by a data processing system of the data processing systems, to be provided to another data processing system of the data processing systems to facilitate performance of a desired computer implemented service. A portion of data may be obtained by receiving the data from an application.

At operation 302, a synchronicity classification for the portion of the data may be obtained, by the data processing system and using a synchronicity classification schema. The synchronicity classification for the portion of the data may be obtained by assessing the characteristics of the portion of the data. The characteristics may be assessed from an analysis of processes that utilize the portion of the data. The processes may include (i) real-time processes (e.g., video streaming, online transactions, real-world sensors, etc.), (ii) high frequency processes (e.g., market trades, the real-world sensors, web analytics, etc.), (iii) coordinated processes (e.g., distributed databases, microservices architecture, manufacturing systems, etc.), etc.

At operation 304, a determination may be made whether the synchronicity classification indicates that the portion of the data is to be distributed synchronously. The determination may be made by reading ingesting synchronicity classification, the synchronicity classification of the portion of the data being either synchronous and/or asynchronous.

If the synchronicity classification indicates that the portion of the data is to be distributed synchronously, the method may continue at operation 306. Otherwise, if the synchronicity classification does not indicate that the portion of the data is to be distributed synchronously, the method may continue in FIG. 3B.

Continuing from operation 304, at operation 306, a channel identifier may be obtained, by the data processing system, for synchronous transmission of the portion of the data to the other data processing system. The channel identifier may be obtained by performing a search, by the data processing system, in a registry of management system 104 that includes channel identifiers. The performance of the search may yield the channel identifier between the data processing system and the other data processing system.

At operation 308, a state of a channel identified using the channel identifier may be identified. The state of the channel may be identified by inferring whether the channel between the data processing system and the other data processing system will be operational during the period of time. The channel may be inferred to operational by receiving, by the data processing system, (i) at least one periodic message from the other data processing system (e.g., discontinuation of the at least one periodic message may indicate the channel is down), (ii) an indicator status (e.g., open, closed, etc.) from a communication protocol relating to the state of the channel when the state of the channel changes, etc.

At operation 310, the portion of the data may be provided, by the data processing system, to the other data processing system while the state of the channel is in a desired state. The portion of the data may be provided by selecting a different period of time during which to transmit the portion of the data to the other data processing system via the channel, in a first instance of the inferring where the channel will not be operational during at least a portion of the period of time. The different period of time may be selected by performing a first scheduling, by the data processing system, of the period of time. The portion of the data may also be provided by selecting the period of time during which to transmit the portion of the data to the other data processing system via the channel in a second instance of the inferring where the synchronous channel will be operational during all of period of time. The period of time may be selected by performing a second scheduling, by the data processing system, of the period of time.

The method may end following operation 310.

Continuing from operation 304, turning to FIG. 3B, at operation 312, a second channel identifier may be obtained, by the data processing system, for asynchronous transmission of the portion of the data to the other data processing system. The second channel identifier may be obtained by performing a second search, by the data processing system, in the registry of a management system that includes the channel identifiers. The performance of the second search may yield the second channel identifier between the data processing system and the other data processing system.

At operation 314, a queue for an asynchronous channel to the other data processing system may be identified by the data processing system. The queue for an asynchronous channel may be identified by performing a third search, by the data processing system, in a file system of the data processing system for the queue.

At operation 316, the portion of the data may be added, by the data processing system, to the queue to facilitate future distribution of the portion of the data to the other data processing system during a period of time when the asynchronous channel is operational. The portion of the data may be added by appending the portion of the data, or perhaps a pointer to the portion of the data in the data processing system, to a list, the list including a timestamp, with the portion of the data and/or the pointer, during which to perform a transmission of the portion of the data from the data processing system to the other data processing system.

Thus, via the method shown in FIGS. 3A-3B, embodiments herein may likely improve a likelihood of managing operation of a deployment of data processing systems. By improving the likelihood of managing operation of a deployment of data processing systems, the data processing systems may be more likely to provide desirable computer implemented services by, for example, classifying the portion of the data as synchronous data and/or asynchronous data, the classification indicating a transmission frequency of the portion of the data for at least one process that is governed by the data processing system and/or the other data processing system, performing a transmission of the synchronous data and/or asynchronous data based on the synchronicity classification, etc.

As discussed above, the components of FIG. 1 may perform various methods to manage operation of a deployment of data processing systems. FIG. 3C illustrates a method that may be performed by the components of the system of FIG. 1. In the diagram discussed below and shown in FIG. 3C, any of the operations may be repeated, performed in different orders, and/or performed in parallel with or in a partially overlapping in time manner with other operations.

Turning to FIG. 3C, a flow diagram illustrating a method of managing operation of a deployment of data processing systems in accordance with an embodiment is shown. The method may be performed, for example, by any of the components of the system of FIG. 1, and/or other components not shown therein.

At operation 320, a grouping instruction may be obtained, by the data processing system, indicating member of the data processing system in a group with the other data processing system. The grouping instruction may be obtained by receiving, from the management system, that the data processing system has been added to at least one grouping of a set of at least one grouping. The set of the at least one grouping may be stored in a second registry in the management system.

At operation 322, the channel and an asynchronous channel to the other data processing system may be established, by the data processing system, the channel being a synchronous channel for timely cooperative action by the data processing system and the other data processing system. The channel and an asynchronous channel may be established by creating a data stream, socket connection, etc. between the data processing system and the other data processing system.

Thus, via the method shown in FIG. 3C, embodiments herein may likely improve a likelihood of managing operation of a deployment of data processing systems. By improving the likelihood of managing operation of a deployment of data processing systems, the data processing systems may be more likely to provide desirable computer implemented services by, for example, organizing data processing systems into at least one grouping, which may frequently transmit data within the one grouping, creating at least two channels, a first channel for at least a first transmission of synchronous data and a second channel for at least a second transmission of asynchronous data, etc.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows®operating system from Microsoft®, Mac OS®/iOS®from Apple, Android®from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment of data processing systems, the method comprising:
obtaining, by a data processing system of the data processing systems, a portion of data to be provided to another data processing system of the data processing systems to facilitate performance of a desired computer implemented service;
obtaining, by the data processing system and using a synchronicity classification schema, a synchronicity classification for the portion of the data;
in a first instance of the obtaining where the synchronicity classification indicates that the portion of the data is to be distributed synchronously:
obtaining, by the data processing system, a channel identifier for synchronous
transmission of the portion of the data to the other data processing system;
identifying, by the data processing system, a state of a channel identified using the channel identifier; and
providing, by the data processing system, the portion of the data to the other data processing system while the state of the channel is in a desired state.

2. The method of claim 1, further comprising:
in a second instance of the obtaining where the synchronicity classification indicates that the portion of the data is to be distributed asynchronously:
obtaining, by the data processing system, a second channel identifier for asynchronous transmission of the portion of the data to the other data processing system;
identifying, by the data processing system, a queue for an asynchronous channel to the other data processing system; and
adding, by the data processing system, the portion of the data to the queue to facilitate future distribution of the portion of the data to the other data processing system during a period of time when the asynchronous channel is operational.

3. The method of claim 1, wherein identifying the state of the channel comprises:
for a period of time during which the portion of the data will be transmitted to the other data processing system:
inferring whether the channel between the data processing system and the other data processing system will be operational during the period of the time.

4. The method of claim 3, wherein providing the portion of the data to the other data processing system while the state of the channel is in the desired state comprises:
in the first instance of the inferring where the channel will not be operational during at
least the portion of the period of the time:
selecting a different period of the time during which to transmit the portion of the data to the other data processing system via the channel.

5. The method of claim 4, wherein providing the portion of the data to the other data processing system while the state of the channel is in the desired state comprises:
in a second instance of the inferring where the channel will be operational during all of the period of the time:
selecting the period of the time during which to transmit the portion of the data to the other data processing system via the channel.

6. The method of claim 5, wherein the period of the time has a duration sufficient to:
distribute the portion of the data to the other data processing system via the channel; and
facilitate obtaining of a response from the other data processing system.

7. The method of claim 6, wherein the response is based, at least in part, on the portion of the data.

8. The method of claim 6, wherein the response is required for the data processing system to provide the desired computer implemented service.

9. The method of claim 8, wherein the desired computer implemented service is a distributed process performed by at least the data processing system and the other data processing system, and the distributed process requires separate timely activity of the data processing system and the other data processing system.

10. The method of claim 1, further comprising:
prior to obtaining the portion of the data:
obtaining, by the data processing system, a grouping instruction indicating
membership of the data processing system in a group with the other data processing system; and
establishing, by the data processing system and based on the grouping instruction, the channel and an asynchronous channel to the other data processing system, the channel being a synchronous channel for timely cooperative action by the data processing system and the other data processing system.

11. The method of claim 1, wherein the data processing systems orchestrates the operation of a manufacturing environment in which timely coordination between the data processing systems is required.

12. A non-transitory machine-readable medium having instructions stored therein, which when executed by a processor, cause the processor to perform operations for managing operation of a deployment of data processing systems, the operations comprising:
obtaining, by a data processing system of the data processing systems, a portion of data to be provided to another data processing system of the data processing systems to facilitate performance of a desired computer implemented service;
obtaining, by the data processing system and using a synchronicity classification schema, a synchronicity classification for the portion of the data;
in a first instance of the obtaining where the synchronicity classification indicates that the portion of the data is to be distributed synchronously:
obtaining, by the data processing system, a channel identifier for synchronous transmission of the portion of the data to the other data processing system;
identifying, by the data processing system, a state of a channel identified using the channel identifier; and
providing, by the data processing system, the portion of the data to the other data processing system while the state of the channel is in a desired state.

13. The non-transitory machine-readable medium of claim 12, wherein the operations further comprise:
in a second instance of the obtaining where the synchronicity classification indicates that the portion of the data is to be distributed asynchronously:
obtaining, by the data processing system, a second channel identifier for asynchronous transmission of the portion of the data to the other data processing system;
identifying, by the data processing system, a queue for an asynchronous channel to the other data processing system; and
adding, by the data processing system, the portion of the data to the queue to facilitate future distribution of the portion of the data to the other data processing system during a period of time when the asynchronous channel is operational.

14. The non-transitory machine-readable medium of claim 12, wherein identifying the state of the channel comprises:
for a period of time during which the portion of the data will be transmitted to the other data processing system:
inferring whether the channel between the data processing system and the other data processing system will be operational during the period of the time.

15. The non-transitory machine-readable medium of claim 14, wherein providing the portion of the data to the other data processing system while the state of the channel is in the desired state comprises:
in the first instance of the inferring where the channel will not be operational during at least the portion of the period of the time:
selecting a different period of the time during which to transmit the portion of the data to the other data processing system via the channel.

16. The non-transitory machine-readable medium of claim 15, wherein providing the portion of the data to the other data processing system while the state of the channel is in the desired state comprises:
in a second instance of the inferring where the channel will be operational during all of the period of the time:
selecting the period of the time during which to transmit the portion of the data to the other data processing system via the channel.

17. A data processing system, comprising:
a processor; and
a memory coupled to the processor to store instructions, which when executed by the processor, cause operations for managing operation of a distributed system of data processing systems to be performed, the operations comprising:
obtaining, by the data processing system of the data processing systems, a portion of data to be provided to another data processing system of the data processing systems to facilitate performance of a desired computer implemented service;
obtaining, by the data processing system and using a synchronicity classification schema, a synchronicity classification for the portion of the data;
in a first instance of the obtaining where the synchronicity classification indicates that the portion of the data is to be distributed synchronously:
obtaining, by the data processing system, a channel identifier for synchronous transmission of the portion of the data to the other data processing system;
identifying, by the data processing system, a state of a channel identified using the channel identifier; and
providing, by the data processing system, the portion of the data to the other data processing system while the state of the channel is in a desired state.

18. The data processing system of claim 17, wherein the operations further comprise:
in a second instance of the obtaining where the synchronicity classification indicates that the portion of the data is to be distributed asynchronously:
obtaining, by the data processing system, a second channel identifier for asynchronous transmission of the portion of the data to the other data processing system;
identifying, by the data processing system, a queue for an asynchronous channel to the other data processing system; and
adding, by the data processing system, the portion of the data to the queue to facilitate future distribution of the portion of the data to the other data processing system during a period of time when the asynchronous channel is operational.

19. The data processing system of claim 17, wherein identifying the state of the channel comprises:
for a period of time during which the portion of the data will be transmitted to the other data processing system:
inferring whether the channel between the data processing system and the other data processing system will be operational during the period of the time.

20. The data processing system of claim 19, wherein providing the portion of the data to the other data processing system while the state of the channel is in the desired state comprises:
in the first instance of the inferring where the channel will not be operational during at least the portion of the period of the time:
selecting a different period of the time during which to transmit the portion of the data to the other data processing system via the channel.
